(19) United States
(12) Patent Application Publication
(10) Pub. No.: US 2005/0160418 A1
(43) Pub. Date: Jul. 21, 2005

(54) Embedded system using binary position information and software downloading method therein

(75) Inventors: Jee-Won Jeong, Anyang-si (KR); Kug Shin, Gunpo-si (KR); Jun-Ho Koh, Suwon-si (KR); Young-Seok Kim, Seongnam-si (KR); Yun-Je Oh, Yongin-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 10/995,451

(22) Filed: Nov. 23, 2004

(30) Foreign Application Priority Data
Jan. 19, 2004 (KR) 2004-4008

(51) Int. Cl. G06F 9/44

(52) U.S. Cl. 717/173; 717/178

(57) ABSTRACT

An embedded system using binary-position information and capable of updating software more promptly is disclosed. The embedded system includes a server for receiving software-version information from a target system for a comparison of a binary image associated with the received software-version information with a binary image corresponding to a new software version and generating a changed binary image and position information in the data to be downloaded, and a target system for analyzing the data downloaded from the server and updating the binary image with reference to the position information.

### CLAIM OF PRIORITY

This application claims priority to an application entitled “Embedded system using binary position information and software downloading method therein,” filed in the Korean Intellectual Property Office on Jan. 19, 2004 and assigned Ser. No. 2004-4008, the contents of which are hereby incorporated by reference.

### BACKGROUND OF THE INVENTION

1. Field of the Invention

The present invention relates to an embedded system and a method for downloading software.

2. Description of the Related Art

An embedded system is provided in consumer products, in which a microprocessor or a microcontroller is embedded as a part of the device to control and monitor its operation. For example, an embedded system may be applied to a mobile communication terminal, or it may be embedded in a device such as a subscriber set-top box for providing broadcasting communications. If the embedded system is incorporated in a subscriber set-top box, a device driver for driving the embedded system, such as a real-time operation system, an application, and other necessary devices, must be embedded in the set-top box. When it is necessary to update the software or the function of the driver due to malfunction or occurrence of bugs in the application, the corresponding software can be remotely downloaded or directly updated from a remote location.

During updating, a new software is typically downloaded to a device, i.e., a set-top box, through a specified channel of an Ethernet port. In this case, the old software is replaced by the newly-downloaded program. Even when only a portion of a source code needs to be changed, the corresponding application is downloaded as whole, and the existing application embedded in the set-top box is completely deleted and replaced with a new application. That is, if the initial source code needs to be corrected, the whole binary file must be downloaded onto the board. The binary file has a size in the range of several KBs to several MBs which in turn lengthens the download time.

As consumers' demands become more diverse, a larger volume of content must be accommodated in a digital media service network where the broadcasting and the communication are integrated. In an optical network setting, which provides such content service, a large number of ONUs is coupled to the terminals located at home. However, the ONUs require frequent software upgrades, and the frequent upgrades take a lot of time and require great cost. In addition, as consumers' requests become more diverse in consumer fields, the software aspect of the products must be updated frequently due to many defects in the devices. To upgrade the software, the binary, which is the execution code for the software download, is typically downloaded through an RS232C, a JTAG or an Ethernet connection

A conventional way of downloading and updating a new software from a server in an embedded system will be briefly explained hereinafter with reference to FIG. 1.

As shown in FIG. 1, a server 100 reads out a binary code from a binary-image storage unit 108, which stores the binary images of the software to be downloaded by a download manager 104, and then transmits the binary to a target system 102 via a server interface 106 using an RS232C, JTAG or Ethernet connection. The target system 102 receives and stores the binary image, via a target system interface 110, in a binary-image storage unit 112. Here, the server 100 transmits the whole binary image of the software for upgrading to the target system 102, and the target system 102 performs the software upgrade by replacing the existing software with the newly-received software. However, it takes more than several minutes to perform the download and update, and this has an adverse effect of disturbing the system development. If it is assumed that several minutes are required for each set-top box installed at home, it will take, therefore, a significant amount of time to perform the software upgrade on multiple set-top boxes. Also, in the case of lending a dedicated channel for the software upgrade from a third company, the cost associated with the lending increases according to the volume of consumed time.

As described above, according to the conventional embedded system, the whole software is downloaded from a server whenever the system performs the software upgrade in a network that provides diverse contents, thus requiring a lot of time and great cost.

### SUMMARY OF THE INVENTION

Accordingly, the present invention has been made to solve the above-mentioned problems occurring in the prior art and provides additional advantages, by providing an apparatus and method that can update the software more promptly in an embedded system.

One aspect of the present invention is to provide an apparatus and method that can reduce the time and cost required for updating the software.

Another aspect of the present invention is to provide an apparatus and method that can update only a changed portion of the existing software during the update process.

Still another aspect of the present invention is to provide an apparatus and method that can reduce the development time even in a debugging environment of an embedded system.

In one embodiment, there is provided an embedded system having a server for providing software and a target system for receiving the software provided from the server. The system includes the server for receiving software-version information from the target system, for comparing a binary image corresponding to the received software-version information with a binary image corresponding to the software-version information to be downloaded, generating a changed binary image and position information data to be downloaded, and for downloading the data to the target system. The system further includes the target system for transmitting the present software-version information to the server, for analyzing the data downloaded from the server, and for updating the changed binary image with reference to the position information if the request for software-version information is received from the server.

In another embodiment, there is provided a software-updating method in an embedded system having a server and a target system, comprising a first step of receiving software-version information from the target system, comparing a binary image corresponding to the received software-version information with a binary image corresponding to the software-version information to be downloaded, generating data to be downloaded as data corresponding to different parts of the two binary images and position information of the corresponding data, and downloading the generated data to the target system, and a second step of, if the data is downloaded to the target system, the target system analyzing the data and updating the binary image according to the position information.

### BRIEF DESCRIPTION OF THE DRAWINGS

The above features and advantages of the present invention will be more apparent from the following detailed description taken in conjunction with the accompanying drawings, in which:

FIG. 1 is a block diagram of a conventional embedded system for downloading software;

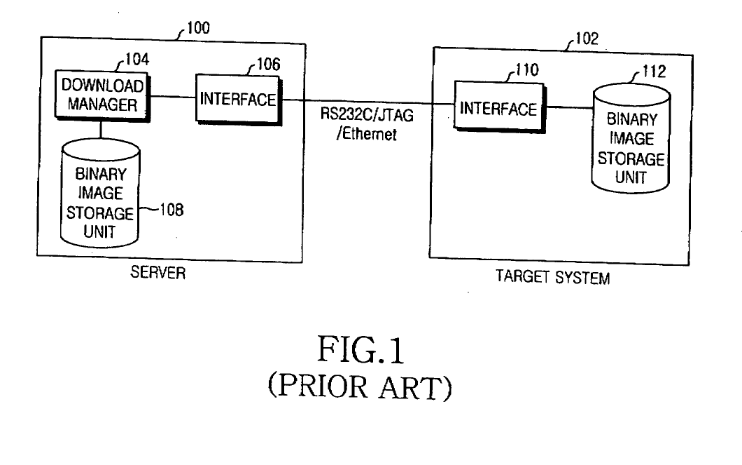

FIG. 2 is a block diagram of an embedded system for downloading software according an embodiment of the present invention;

FIG. 3 is a control flowchart illustrating the downloading process by a sever to a target system according to an embodiment of the present invention;

FIG. 4 is a control flowchart illustrating a target system's downloading of software received from a server according to an embodiment of the present invention;

### DETAILED DESCRIPTION OF THE INVENTION

Hereinafter, an embedded system and a software-downloading method therein according to embodiments of the present invention will be described with reference to the accompanying drawings. For the purposes of clarity and simplicity, a detailed description of known functions and configurations incorporated herein will be omitted as it may make the subject matter of the present invention unclear.

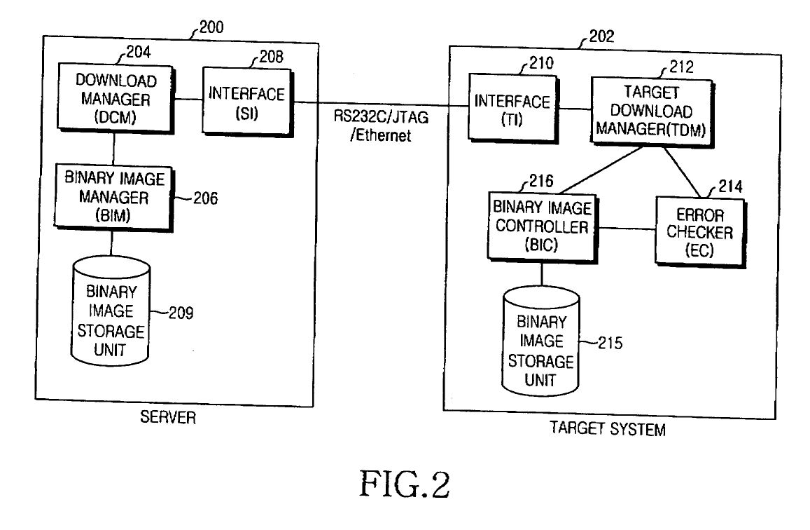

FIG. 2 is a block diagram of an embedded system for downloading and updating a software according to an embodiment of the present invention. A server 200 includes a download control manager (DCM) 204 for managing a download of the binary image files to a remote server or target system 202, a server interface (SI) 208 for performing the transmission/reception of the files and data to/from a target system 202, a binary-image manager (BIM) 206 for generating the binary images to be provided to the target system 202, and binary image storage unit 209 for storing binary image files.

The target system 202 may be a set-top box or other consumer-electronic devices installed in a remote place, or a terminal such as an ONU. The target system 202 includes a target interface (TI) 210 to transmit/receive files and data to/from the remote server 200, a binary image controller (BIC) 216 for managing information of the binary images, receiving and changing a new binary image, a target download manager (TDM) 212 for managing the software download process, an error checker (EC) 214 for checking the validation of the received data, and a binary image storage unit 215 for storing binary image files.

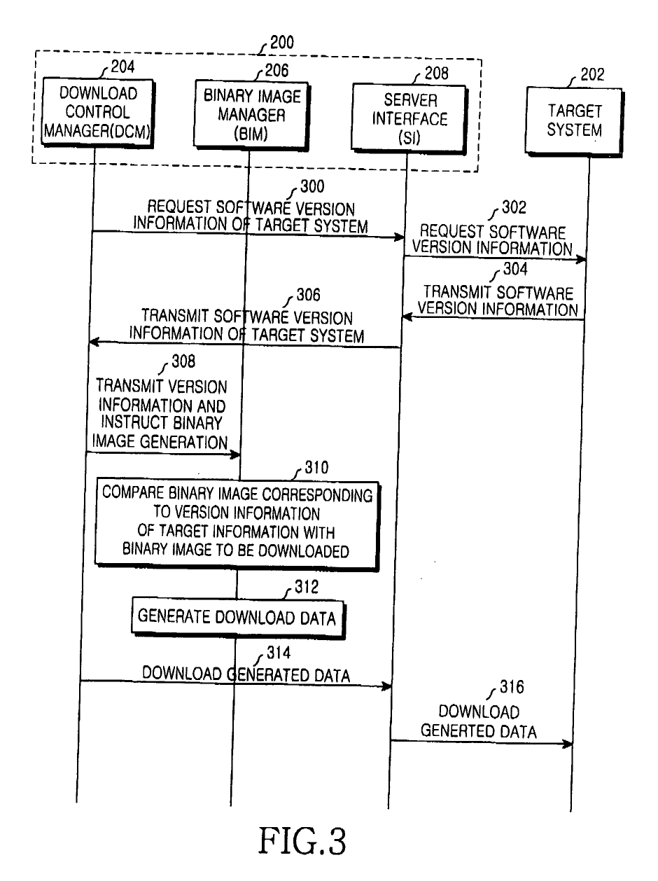

Now, referring to FIG. 3, the operation of the server 200 for executing the software download from a server 200 to a target system 202 according to the teachings of the present invention will be explained.

In operation, the download control manager 204 requests the binary-version information of the target system 202 through the server interface 208 at steps 300 and 302. Then, in response to the server's request for the binary-version information, the target system 202 transmits information relating to its own binary image at step 304. The server interface 208 transmits the received-version information to the download control manager 204, and in turn, the download control manager 204 transmits the binary-version information of the target system 202 to the binary-image manager 206 and instructs the generation of the binary image at step 308.

The binary-image manager 206 generates the binary image to be downloaded to the target system 202. To this end, the binary-image manager 206 receives the binary-version information of the target system 202 at step 310, and compares the binary image associated with the binary-version information of the target system 202 with a new binary image among the binary images managed by the server 200. The process of comparing the binary images is not performed in a manner in which all addresses of the respective binary images are compared one by one, thus contributing to inefficiency. Instead, the comparison is performed in such a manner that data having the same size (a window) are compared with one another using a comparison window scheme in order to improve the downloading efficiency, as further explained hereinafter.

If (A) is a binary image of an old version and (B) is a binary image of a new version, to which the target system is to be updated to, a window size may be defined as 10 and a shift margin of the window may be defined as from −5 to +5. Note that a user can optionally set the value of a shift margin and the size of a window. The server 200 compares data of an N unit sized window of the file (A) with data of the window shifted from −5 to −4, to −3 to −2 . . . 5 of the file (B) to see if they are in complete accord with each other. Here, the window size is 1×N (row×column) and the N is a variable size, the first window consists of the first byte to the N-th byte when scanning the binary file. The second window consists of the (N+1)-th byte to (N+N)-th byte. Generally, the M-th window may be represented as the ((M×N)+1)-th to ((M×N)+N)-th byte. In this fashion, the windows having a series of bytes are used to compare the bytes of the binary file of an existing downloaded version.

If the data is completely in accord, the value of the shift margin obtained at this time is known as the “same count.” Hence, the data are determined to be the same when the n-th to (n+S)-th windows match the m-th to (m+S)-th windows in the binary file of the target system version.

Meanwhile, if they are not in accord, the file (A) continuously compare its byte values in the window size with the byte values of the file (B), by increasing or reducing the position, one by one, according to a predefined shift margin until the byte values of a completely accorded window size is found. Here, if the position of a shift is represented as +s in the m-th window of the file (B), then (m×N+s) of the file (A) becomes the position information of the m-th window. Note that a series of byte values in the m-th window of the file (B) file includes the same data in window size N at (m×N+s) position of the file (A). This process is performed in the whole window of the file (B). Accordingly, in case that the data in the window of the file (B) exists in the file (A), the position information of the same data can be found. If the same data does not exist, binary image manager 206 stores where the window is positioned for different window data of the file (B). Further, the binary image manager 206 stores the actual data of the file (B). Here, a flag value can be used to determine whether the same data exist.

For example, if a target system receives 102 an update signal, the file to be downloaded is analyzed and a new binary file is formed. The file in the target system 102 is substituted or supplemented by the newly formed binary file. In order to perform such a process, the file to be downloaded is analyzed by dividing it into a head region, a data region, and an end region. Upon receipt, the data region is analyzed. It is firstly determined where the window is positioned. And then, according to the flag value, the bytes corresponding to the bytes of the window size determines whether to update its binary file. If the flag=0, the target system, since the same data exists, confirms the margin shift value of 4 bytes which is behind the flag, finds a series of bytes according to information in the binary file (i.e., position of window+shift value. If, on the other hand, the flag=1, the target system 102 extracts the window size and the corresponding real data in the downloaded binary file, including the data in the position according to the information of the new file (i.e., position of window+shift value). Through the above process, the analysis of the downloaded file is completely performed, thereby making a construction of a new, updated, file in the target system.

At step 312, the data to be transmitted is generated after the image comparison. Here, the generated data derived from two image files compared at step 310 is based on a comparison between a new image file of a version and an image file of a version already set in the target system. In particular, the generated data comprises differences between the two compared image files. That is, a new file (referred to as CC) to be downloaded is divided into a header region, a data region, and an end region. The header region consists of (size information of the file CC)+(version information of file B)+(the window size)+(whole window number), etc. The data region comprises an unit having (sequence number of window)+(flag)+{(if flag=0, shift position information of window) or (if flag=1, data size+actual data)}. Such a unit exists for each window number where differences are determined.

As the aforementioned steps, the window is compared as a shift count, one by one, from the first position of the two files, and data including image-version information, position information, and window size are generated. Thus, the newly generated data includes position information and actual data. That is, in the case that a series of data value within an n-th window that exists from a −s shift margin to a +s sift margin at the n-th window position of software binary file contained in the software image to be downloaded, only the position information is stored. Otherwise, the (window size)+(data in window) is stored.

The generated packet data further includes a header, the generated data, and a CRC32 or check-sum. The size of the packet data may be set optionally, and in the present invention, it is assumed that the size of the packet data is in the range of 512 bytes to 4 kbytes since the maximum packet size of 4 kbytes is generally supported in a LAN environment. That is, the generated data is divided into a packet of the same size and transmitted by adding a value for a header and an error check into the end of packet data. The newly-updated version information is inserted at the head of these files.

More specifically, the header region comprises a preamble, a source ID, a target ID, a current packet number, a last packet number, and a packet length. The data region comprises an offset of 4 bytes, a data size of 2 to 4 bytes, and corresponding data. The error-check region comprises the CRC32 or checksum. Also, the last packet includes the CRC32 value of the software binary image to be updated.

Finally, at steps 314 and 316, the data packet as generated above is downloaded to the target system 202 through the server interface 208.

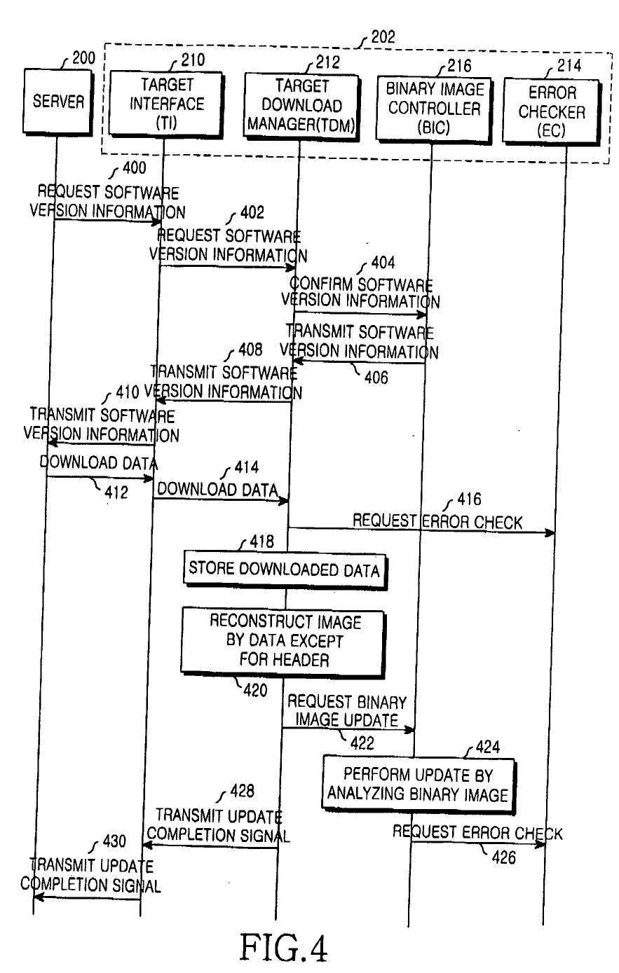

Now, with reference to FIG. 4, the operation of the target system 202 for downloading software will be explained.

First, the target interface 210 receives a request for the version information of the binary image from the server 200 at step 400 (or step 302 of FIG. 3) and relays the request to the target download manager 212. In response, the target download manager 212 checks the version information of the current binary image set in the current target system 202 from the binary image controller 216 through steps 404 and 406. The target download manager 212 transmits the confirmed binary image version information to the server 200 through steps 408 and 410.

Thereafter, the operation described in connection to FIG. 3 is performed during which the newly-generated data is generated and downloaded from the server 200 at steps 412 and 414. The target download manager 212 requests an error check of the data packet downloaded from the server 200 to the error checker 214. At this time, if an error exists, the target download manager 212 requests only the retransmission of the corresponding packer in which the error occurs, and then it stores the packet downloaded at step 418 in a memory 215. Then, the target download manager 212 reconstructs the image using the data obtained by excluding the header from the data packet received from the server 200 at step 420.

If the image update is requested to the binary image controller 216 at step 422, the binary image controller 216 performs the update by analyzing the binary image. Then, the binary image controller 216 performs the update by analyzing version information, position information, and value corresponding to a window size from the downloaded binary image at step 424.

More specifically, the binary of the target system 202 is reconstructed by analyzing the header information, searching for the position information to be updated with reference to the offset (shift) value of the downloaded data region, changing the size of the data to be changed to the data-size value of the data region, and changing the actual value already stored to the data value of the transmitted data region. The error check is performed by the error checker 214 using the reconstructed image and the CRC32 or check-sum value included in the last packet.

Accordingly, the server 200 transmits a number of packets containing the updated binary information to the target system 202, then the target system 202 removes the header and check-sum from the received packets and sequentially assembles only the pure data so that one binary image is constructed. The constructed image file used to update the target system 202, for example, comprises image-version information+(position information+byte value of window size/position information+byte value of window size/position information+byte value of window size/etc.)+checksum (CRC32).

Finally, a software update completion signal is transmitted to the server 200 at steps 428 and 430.

As described above, during the update of the contents-related software, the whole software is not downloaded, but only the data to be changed is transmitted/received, so that the software can be upgraded more efficiently and quickly. Accordingly, the present invention has the advantages in that it can promptly upgrade the software by reconstructing different parts between the software corresponding to the version information of the target system and the new software, and then downloading only the changed parts. Hence, as the downloading speed becomes faster, the software upgrade and the debugging times can be shortened. Note that the target system may include a set-top box, but it can be applied to any terminal having an embedded software.

While the invention has been shown and described with reference to certain preferred embodiments thereof, it will be understood by those skilled in the art that various changes in form and details may be made therein without departing from the spirit and scope of the invention as defined by the appended claims.

1. An embedded system comprising:
a server for receiving software information received from a target system and generating data including a changed binary image and position information of the data to be downloaded based on a comparison outcome of a binary image corresponding to the received software information and a binary image corresponding to new software information, wherein the target system is configured to analyze the downloaded data from the server and update a change in the binary image with reference to the position information.

2. The embedded system as claimed in claim 1, wherein the server comprises:
an interface for transmitting/receiving data to/from the target system;
a download control manager for generating the binary image of the new software information; and,
a binary-image manager for comparing the binary image associated with the software information from the target system with the binary image of the new software information, and generating the data including the changed binary-image information and the position information.

3. The embedded system as claimed in claim 2, wherein the binary-image manager generates the data comprising a header field, a data field having the position information, and the change binary image of the new software information to be downloaded, and an error-check field.

4. The embedded system as claimed in claim 2, wherein the binary-image manager uses a predetermined window for comparing the binary image associated with the received software information and a binary image corresponding to new software information

5. The embedded system as claimed in claim 1, wherein the target system comprises:
an interface for transmitting/receiving data to/from the server;
a binary-image controller for providing the software information and performing the update by analyzing data downloaded from the server;
a target download manager for storing the data downloaded from the server and outputting a signal for requesting an image update; and,
a binary-image controller for recognizing the position information and analyzing the downloaded data, and updating the a binary-image in a position corresponding to the position information when the image update signal is inputted from the target download manager.

6. The embedded system as claimed in claim 5, wherein the target system further comprises an error checker for checking the validation of the downloaded data if an error check is requested from the binary-image controller.

7. A software updating method in an embedded system having a server and a target system, comprising the steps of:
a first step of receiving software-version information from the target system, further comprising the steps of:
comparing a binary image corresponding to the received software-version information with a binary image corresponding to a new software-version information; and
downloading to the target system data including changed binary-image information and position information; and,
a second step of analyzing the downloaded data and updating the binary image of the target system according to the position information.

8. The software updating method as claimed in claim 7, wherein the first step further comprises the steps of:
requesting the software version information from the target system and receiving the requested software-version information from the target system; and,
comparing the binary image corresponding to the software-version information of the target system with the binary image corresponding to the new software-version information to be downloaded, and generating the data to be downloaded as data corresponding to different parts of the two binary images and the position information of the data.

9. The software updating method as claimed in claim 7, wherein the second step further comprises the steps of:
recognizing the position information to be updated by analyzing the downloaded data, and updating the binary-image stored in the target system in a position corresponding to the position information.

10. The software-updating method as claimed in claim 8, wherein the step of generating the data to be downloaded comprises the step of:
generating the data comprising a header field, a data field having the position information and the binary-image data to be downloaded, and an error-check field.

11. The software updating method as claimed in claim 8, wherein the binary-image manager uses a predetermined window for comparison and compares each set of binary images as large as the size of the window when the binary-image manager compares the binary images.

12. The software updating method as claimed in claim 11, wherein if the binary images are different from one another, it is checked whether the same bytes exist throughout the image file by continuously shifting the data corresponding to the window size of the corresponding position of the binary image of the version to be downloaded as large as the window size, starting from the corresponding position of the binary image of the version existing in the target system.

13. The software updating method as claimed in claim 12, wherein if the matched data exist during the checking operation as the n-th window moves, the same count S is preset for a reliability verification of the data, it is checked if the same data match from an n-th to (n+S)-th windows, and if so, the data are judged to be the same, while if not, the data are judged to be different.
